(19) United States
(12) Patent Application Publication
(10) Pub. No.: US 2014/0374430 A1
(43) Pub. Date: Dec. 25, 2014

(54) DISPENSER ASSEMBLY

(71) Applicant: 3M Innovative Properties Company, Saint Paul, MN (US)

(72) Inventors: THOMAS C. MEIER, WOODBURY, MN (US); MARTHA E. LOPEZ-IBARRA, MEXICO CITY (MX)

(21) Appl. No.: 14/305,035

(22) Filed: Jun. 16, 2014

Related U.S. Application Data
(60) Provisional application No. 61/836,749, filed on Jun. 19, 2013.

(51) Int. Cl. G07F 11/02

(52) U.S. Cl. CPC G07F 11/02
USPC 221/1; 221/198

(57) ABSTRACT

The disclosure relates to a dispenser assembly comprising a bin with a spring actuated shuttle for engaging with a plurality of individual dispensable units contained within a refill package. The disclosed dispenser assembly provides easy dispensing of individual dispensable units from a bin. The individual dispensable units are contained within a refill package for easy reloading. In one embodiment, a tool is used to remove an individual dispensable unit and therefore the dispensing is achieved without touching the individual dispensable unit with the user's hands.

### CROSS-REFERENCE TO RELATED CASES

The present disclosure claims priority to U.S. Provisional Application 61/836,749 filed on Jun. 19, 2013.

### BACKGROUND

The disclosure relates to a dispenser assembly comprising a bin and a refill package. In particular, the dispenser assembly comprises a bin with a spring actuated shuttle for engaging with a plurality of individual dispensable units contained within a refill package.

Dispensing containers are used to hold a variety of items such as, for example, food, cans, and cleaning items. In some situations a user may not want to touch the items with their hand. For example, a user may be holding a cleaning tool and wants the item to connect with the tool directly instead of grabbing the item with a hand to apply to the cleaning tool. Commonly, dispensers simply hold items and do not position the items to individually align for dispensing. Such dispensers are not well suited for hands-free dispensing of the items onto a tool. Further, once the items are used, refilling the dispenser can be difficult where ordered, individually aligned dispensing is desired.

### SUMMARY

The disclosed dispenser assembly provides easy dispensing of individual dispensable units from a bin. The individual dispensable units are contained within a refill package for easy reloading into the bin. In one embodiment, a tool is used to remove an individual dispensable unit and therefore the dispensing is achieved without touching the individual dispensable unit with the user's hands.

In one embodiment, the dispensing assembly comprises a bin and a refill package. The bin comprises a shuttle, a spring connected with the shuttle, and a bin dispensing opening. The refill packages comprises a top wall, a bottom wall, and a sidewall for containing a plurality of dispensable units, a removable sidewall opening, a removable refill dispensing opening, wherein removal of the sidewall opening form a continuous channel for slidably receiving the shuttle. The refill package is contained within the bin. The spring actuates the shuttle to position one of the plurality of dispensable units adjacent the refill dispensing opening and bin dispensing opening.

In one embodiment, the refill package comprises a top wall, bottom wall, and sidewall for containing a plurality of dispensable units, a removable bottom wall opening, a removable sidewall opening, a removable refill dispensing opening. Removal of the removable bottom wall opening and removable sidewall opening form a continuous channel. Removal of the removable refill dispensing opening allow for dispensing of each dispensable unit.

In one embodiment, a method of dispensing a dispensable unit comprises enclosing a plurality of dispensable units within a refill package, wherein the refill package comprises a removable bottom wall opening, a removable sidewall opening, and a removable refill dispensing opening, removing the removable bottom wall opening, the removable sidewall opening, and the removable refill dispensing opening to form a bottom wall opening, sidewall opening, and refill dispensing opening, inserting the refill package into a bin, wherein the bin comprises a spring connected with a shuttle such that the shuttle enters the bottom wall opening to engage with a dispensable unit, actuating the plurality of dispensable units adjacent the refill dispensing opening and bin dispensing opening with the spring and shuttle.

### BRIEF DESCRIPTION OF THE DRAWINGS

FIG. 1 is a perspective view of one embodiment of a dispenser assembly;

FIG. 2 is a perspective view, showing the front and top, of one embodiment of a refill package for use with the dispenser assembly;

FIG. 3 is a perspective view of the refill package of FIG. 2, showing the rear and bottom;

FIG. 4 is a perspective view of the refill package of FIG. 2-3 engaged with a shuttle for use within the dispenser assembly;

FIG. 5 is an exploded perspective view of the dispenser assembly of FIG. 1;

FIG. 6 is a perspective view of one embodiment of a tool for use with the dispenser assembly;

FIG. 7 is a perspective view of one embodiment of a dispensable unit contained within the dispenser assembly.

While the above-identified drawings and figures set forth embodiments of the invention, other embodiments are also contemplated, as noted in the discussion. In all cases, this disclosure presents the invention by way of representation and not limitation. It should be understood that numerous other modifications and embodiments can be devised by those skilled in the art, which fall within the scope and spirit of this invention. The figures may not be drawn to scale.

### DETAILED DESCRIPTION

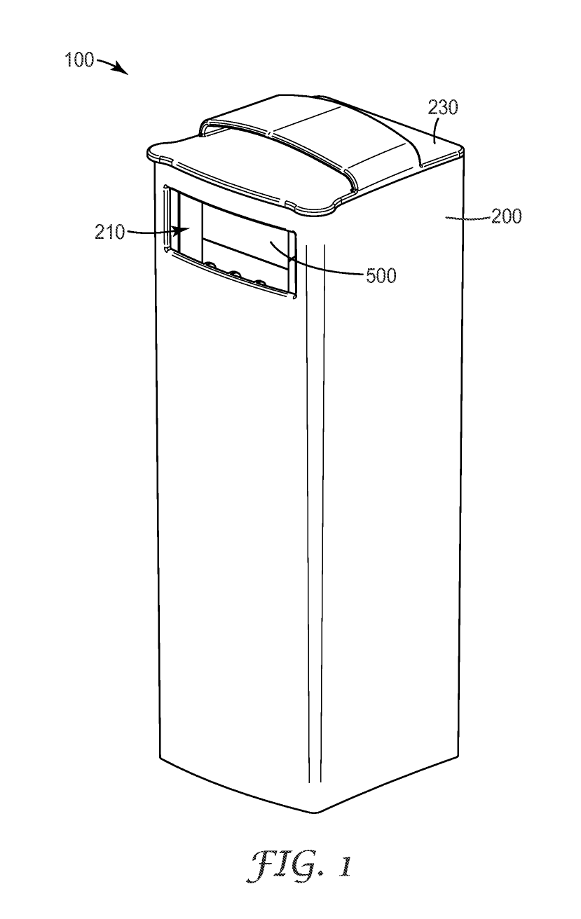

FIG. 1 is a perspective view of one embodiment of a dispenser assembly 100. The dispenser assembly 100 comprises a bin 200 and a refill package 300. The refill package 300 contains a plurality of dispensable units 500. During use, the refill package 300 is inserted into the bin 200.

The bin 200 holds the refill package 300 and includes a bin dispensing opening 210 for removing a dispensable unit 500 from the bin 200. Within the bin 200 is a shuttle 220 and spring 224 for actuating individual dispensable units 500 to the bin dispensing opening 210. The location and arrangement of the shuttle 220, spring 224, and shuttle track 222 to be in any location within the bin 200 to achieve the purpose of advancing the dispensable units 500. In one embodiment, the bin 200 includes a cover 230 for holding the refill package 300 within the bin 200. In one embodiment, the bin 200 is constructed from a durable material, such as, for examples, plastic or metal.

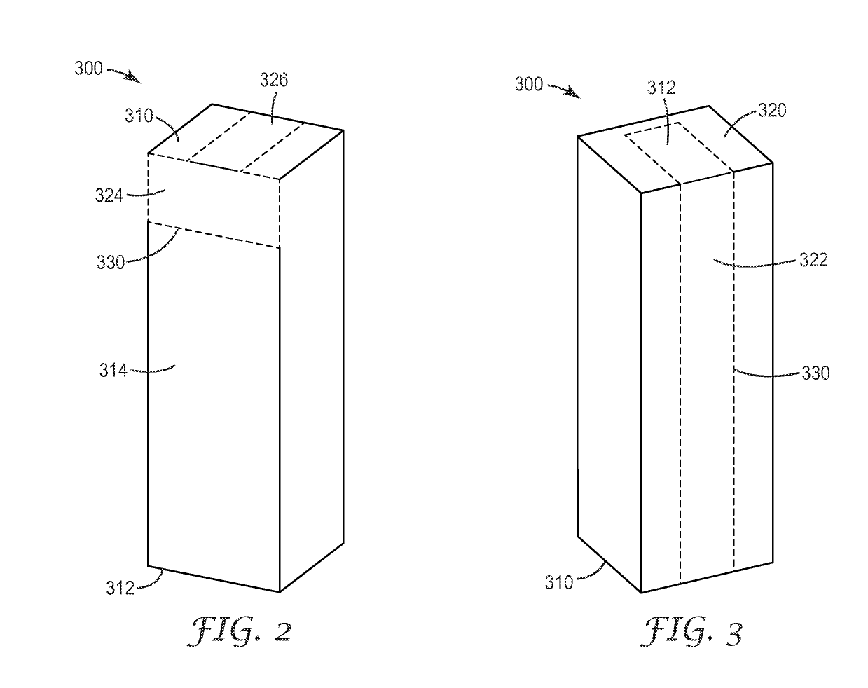

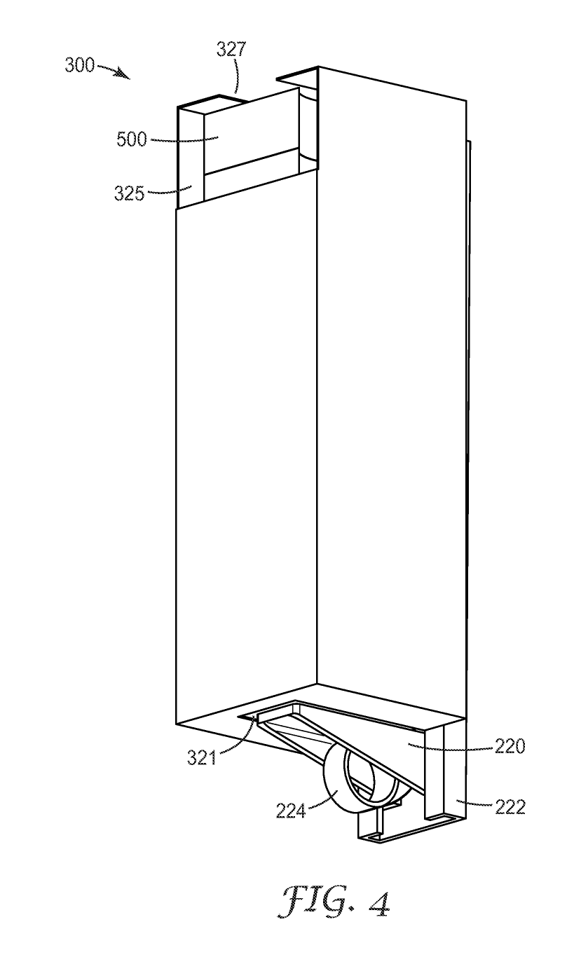

FIG. 2 is a perspective view, showing the front and top, of one embodiment of a refill package 300, while FIG. 3 is a perspective view of the refill package of FIG. 2, showing the rear and bottom. The refill package 300 includes a top 310, bottom 312 and side walls 314 to hold a plurality of the dispensable units 500. FIGS. 2 and 3 show that at the bottom 312 is a removable bottom opening 320, at the sidewall 314 is a removable sidewall opening 322 and a removable refill dispensing opening 324, and at the top 310 is a removable top opening 326. The removable bottom opening 320 and removable top opening 326 are optional. Areas of weakness 330 in the refill package form the removable bottom opening 320, removable sidewall opening 322, removable refill dispensing opening 324, and removable top opening 326 so that each of these openings can be easily separated from the refill package. In one embodiment, the area of weakness 330 is a perforation line. In one embodiment, the removable bottom opening 320, removable sidewall opening 322, removable refill dispensing opening 324, and removable top opening 326 are constructed from a thinner or less durable material, like foil or thin film, than the remainder of the refill package 300.

While in place, the removable bottom opening 320, removable sidewall opening 322, removable refill dispensing opening 324, and removable top opening 326 along with the top 310, bottom 312 and sidewalls 314 form a complete container for holding the dispensable units 500. For example, the refill package 300 can be sold individually and purchased for placement into the bin 200. In one embodiment, the refill package 300 is constructed from a less durable, disposable material, such as, for example, paper or plastic.

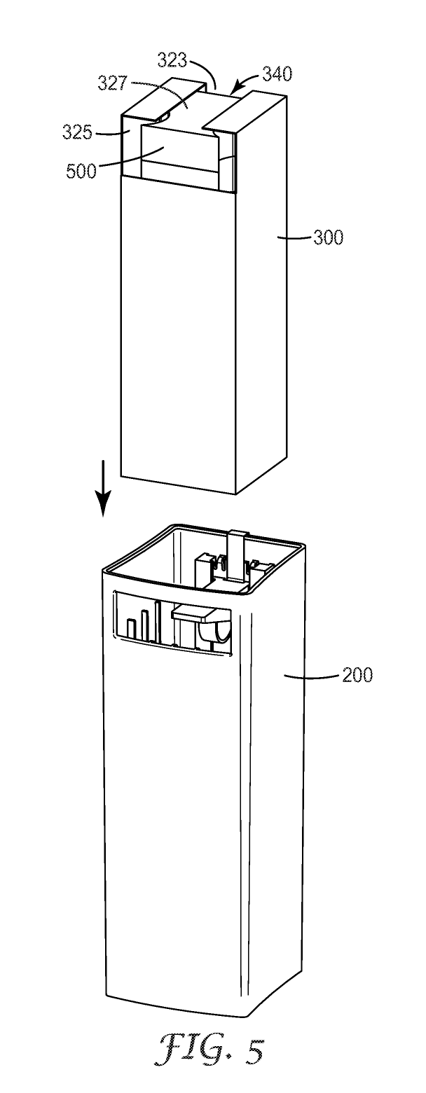

Prior to inserting the refill package 300 into the bin 200 for use, the removable bottom opening 320, removable sidewall opening 322, and removable refill dispensing opening 324 are removed to form a bottom opening 321, sidewall opening 323, and refill dispensing opening 325. In the embodiment where a removable top opening 326 is included is can be removed to form a top opening 327. The bottom opening 321 continuously connects with the sidewall opening 323 to form a channel 340 for slidably receiving the shuttle 220, see FIGS. 3 and 5. The refill dispensing opening 325 is for removing a dispensable unit 500 from the refill package 300.

FIG. 4 is a perspective view of the refill package 300 of FIGS. 2-3 engaged with a shuttle 220 for use within the dispenser assembly 100. In FIG. 4, the bin 200 has been removed to more clearly show the interaction of the shuttle 220 with the refill package 300 and contained dispensable units 500. In this embodiment, the mechanism for actuating the dispensable units 500 comprises the shuttle 220, shuttle track 222, and spring 224. It is understood that the shuttle track 222, shuttle 220, and spring 224 are connected with the bin 330. The shuttle track 222 provides a track for the shuttle 220 to slide along from a bottom to the top of the bin 200. The spring 224 enables the slidable movement. In this embodiment, the spring 224 is a constant force spring. In another embodiment, a shuttle 220 and compression spring could be provided for the needed force.

As can be seen in FIG. 4, the bottom opening 321 of the refill package 300 is slightly larger than the shuttle 220 so that the shuttle 220 can fit within the refill package 300 and engage with the lowermost dispensable unit 500. The channel 340 formed by the continuous connection between the bottom opening 321 and sidewall opening 323 allows for the shuttle 220 to slidably move along the refill package 300, raising the plurality of dispensable units 500 while a dispensable unit 500 is removed from the refill package 300 and bin 500. In one embodiment, such as shown in FIG. 4, the removable top opening 326 connects with the removable sidewall opening 322, removable refill dispensing opening 324, and removable bottom opening 320. This allows for a continuous section of material to be removed to form the bottom opening 321, sidewall opening 323, top opening 327 and refill dispensing opening 325. It is understood that the top opening 327 and bottom opening 325 are not necessary and an alternative design could include the refill dispensing opening 325 on the same surface as the side wall opening 323.

FIG. 5 is an exploded perspective view of the dispenser assembly 100 of FIG. 1. The refill package 300 with the bottom opening 321, sidewall opening 323, and refill dispensing opening 325 and contained dispensable units 500 are inserted into the bin 200. In one embodiment, the bin 200 includes a cover 230 for securely containing the refill package 300 in the bin 200. The shuttle 220 engages into the bottom opening 320 and with the lowermost dispensable unit 500. The shuttle 220 slides down the shuttle track 222 from the force applied by the user to insert the refill package 300 into the bin 200 and held in place by the cover 230.

During use, a dispensable unit 500 dispenses from the refill dispensing opening 325 and out the bin dispensing opening 210. The spring 224 will actuate the shuttle 220 upward along the shuttle track and along the channel 340 raising the lowermost dispensable unit 500 so that another dispensable unit 500 can be dispensed from the refill dispensing opening 325 and out the bin dispensing opening 210. When the dispensable units 500 have all been dispensed, the refill package can be removed and either refilled or discarded.

FIG. 6 is a perspective view of one embodiment of a tool 400 that may optionally be used with the dispenser assembly 100. The tool 400 comprises a handle 410 and opposite from the handle 410 is a working end 420 that includes a first engagement 425 for connecting with a dispensable unit 500. The tool 400 shown in this embodiment is generally elongated and can be used for cleaning a toilet. It is understood that any number of sizes, shapes, and configurations of tools 400 and first engagement 424 mechanisms may be used to interact with the dispensable unit 500 contained within the dispenser assembly 100.

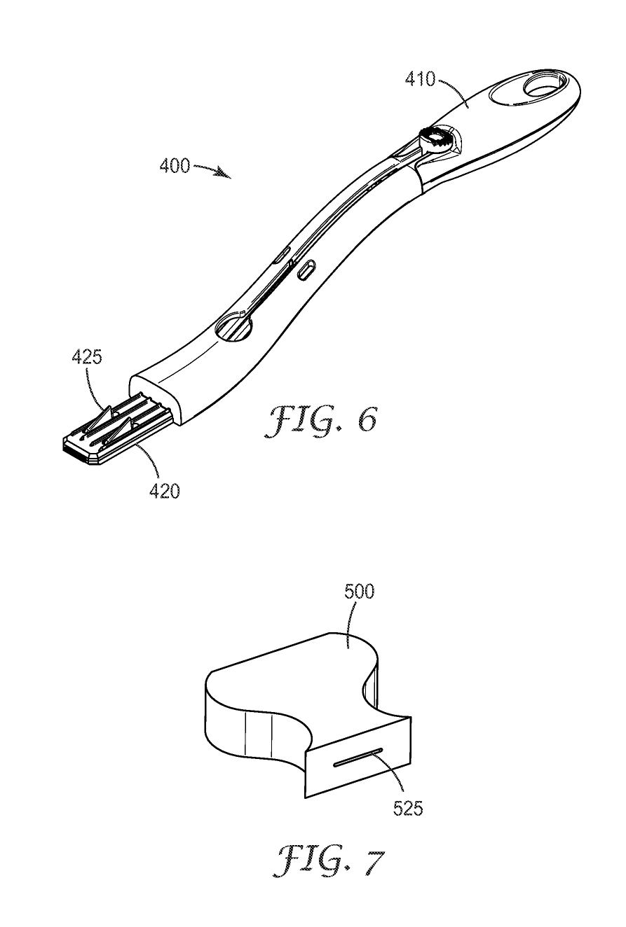

FIG. 7 is a perspective view of one embodiment of a dispensable unit 500 contained within the dispenser assembly 100. In this embodiment, the dispensable unit 500 is used for cleaning and it a lofty, low-density nonwoven web of fibers. It is understood that any kind of dispensable unit 500 may be used in the dispenser assembly 100, such as, but not limited to, food, cans, cleaning chemicals/detergents or cleaning articles. Further, cleaning articles can be made from a variety of substrates which comprise woven, knitted, nonwoven fabrics, sponge or foam, or a combination of one or more substrates. The cleaning article may comprise cleaning detergents, chemicals, scouring or abrasive products. When a tool 400 is used to remove the dispensable unit 500 from the dispenser assembly 100, the dispensable unit 500 typically includes a second engagement 5250 for connecting with the first engagement 425 of the tool 400.

In the embodiment shown in FIGS. 6 and 7, the second engagement 525 is a slot into the body of the dispensable unit 500. The first engagement 425 is a projecting section with barbs to prevent the first engagement 425 from inadvertently slipping out of the slot. It is understood that a variety of other mechanical or adhesive attachments could be used to connect the tool 400 with the dispensable unit 500.

Although specific embodiments of this invention have been shown and described herein, it is understood that these embodiments are merely illustrative of the many possible specific arrangements that can be devised in application of the principles of the invention. Numerous and varied other arrangements can be devised in accordance with these principles by those of ordinary skill in the art without departing from the spirit and scope of the invention. Thus, the scope of the present invention should not be limited to the structures described in this application, but only by the structures described by the language of the claims and the equivalents of those structures.

What is claimed is:

1. A dispensing assembly comprising:
a bin comprising:
a shuttle;
a spring connected with the shuttle;
a bin dispensing opening;
a refill package comprising:
a top wall, a bottom wall, and a sidewall for containing a plurality of dispensable units;
a removable sidewall opening;
a removable refill dispensing opening;
wherein removal of the sidewall opening form a continuous channel for slidably receiving the shuttle;
wherein the refill package is contained within the bin;
wherein the spring actuates the shuttle to position one of the plurality of dispensable units adjacent the refill dispensing opening and bin dispensing opening.

2. The dispenser assembly of claim 1, wherein the bin comprises a shuttle track for slidably receiving the shuttle.

3. The dispenser assembly of claim 1, wherein the spring is a compression spring.

4. The dispenser assembly of claim 1, wherein the spring is a constant force spring.

5. The dispenser assembly of claim 1, further comprising a cover for securely containing the refill package within the bin.

6. The dispenser assembly of claim 1, wherein the refill package further comprises a removable bottom wall opening.

7. The dispenser assembly of claim 1, wherein the refill package further comprises a removable top opening.

8. The dispenser assembly of claim 1, wherein the refill package comprises:
a sidewall opening;
a refill dispensing opening.

9. The dispenser assembly of claim 1, wherein the refill package comprises:
a top opening;
a bottom opening.

10. The dispenser assembly of claim 9, wherein the bottom opening, sidewall opening, top opening and refill dispensing opening are continuously connected.

11. The dispenser assembly of claim 1, wherein the refill package comprises a plurality of perforations to form the removable sidewall opening and removable refill dispensing opening.

12. The dispenser assembly of claim 11, wherein the plurality of perforations of the removable sidewall opening and removable refill dispensing opening connect together so that removal of the removable sidewall opening also removes the removable refill dispensing opening.

13. The dispenser assembly of claim 1, wherein the refill package contains a plurality of individual dispensable units individually stacked one on top of another.

14. The dispenser assembly of claim 9, wherein the bottom wall opening is slightly larger than the shuttle.

15. The dispenser assembly of claim 9, wherein the sidewall opening and refill dispensing opening are on the same surface of the refill package.

16. The dispenser assembly of claim 9, wherein the sidewall opening and refill dispensing opening are on opposite surfaces of the refill package.

17. The dispenser assembly of claim 1, wherein the refill package comprises a top wall, bottom wall, and sidewalls to substantially contain the dispensable units.

18. The dispenser assembly of claim 1, further comprising a tool for engaging with a dispensable unit to remove the dispensable unit from the bin dispensing opening and the refill dispensing opening.

19. The dispenser assembly of claim 18, wherein the tool comprises a first engagement surface to connect with a second engagement surface of the dispensable unit.

20. The dispenser assembly of claim 18, wherein the tool is a cleaning tool and the dispensable unit is a cleaning device.

21. The dispenser assembly of claim 18, wherein the tool is a toilet bowl tool and the dispensable unit is a toilet scrubbing device.

22. A refill package comprising:
a top wall, bottom wall, and sidewall for containing a plurality of dispensable units;
a removable bottom wall opening;
a removable sidewall opening;
a removable refill dispensing opening;
wherein removal of the removable bottom wall opening and removable sidewall opening form a continuous channel; and
wherein removal of the removable refill dispensing opening allow for dispensing of each dispensable unit.

23. A method of dispensing a dispensable unit comprising:
enclosing a plurality of dispensable units within a refill package, wherein the refill package comprises a removable bottom wall opening, a removable sidewall opening, and a removable refill dispensing opening;
removing the removable bottom wall opening, the removable sidewall opening, and the removable refill dispensing opening to form a bottom wall opening, sidewall opening, and refill dispensing opening;
inserting the refill package into a bin, wherein the bin comprises a spring connected with a shuttle such that the shuttle enters the bottom wall opening to engage with a dispensable unit;
actuating the plurality of dispensable units adjacent the refill dispensing opening and bin dispensing opening with the spring and shuttle.
